(19) United States
(12) Patent Application Publication
(10) Pub. No.: US 2005/0018601 A1
(43) Pub. Date: Jan. 27, 2005

(54) Traffic management

(76) Inventors: Suresh Kalkunte, Marlborough, MA (US); Hugh Wilkinson, Newton, MA (US); Gilbert Wolrich, Framingham, MA (US); Mark Rosenbluth, Uxbridge, MA (US); Donald Hooper, Shrewsbury, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/612,552

(22) Filed: Jul. 1, 2003

Related U.S. Application Data
(63) Continuation-in-part of application No. 10/176,298, filed on Jun. 18, 2002.

(51) Int. Cl. H04L 1/00

(52) U.S. Cl. 370/229

(57) ABSTRACT

In general, in one aspect, the disclosure describes a system to process packets received over a network. The system includes a receive process of at least one thread of a network processor to receive data of packets belonging to different flows. The system also includes a transmit process of at least one thread to transmit packets received by the receive process. A scheduler process of at least one thread populates at least one schedule of flow service based, at least in part, on quality of service characteristics associated with the different flows. The schedule identifies different flow candidates for service. The system also includes a shaper process of at least one thread to select from the candidate flows for service from the at least one schedule.

### REFERENCE TO RELATED APPLICATIONS

This application claims priority to, and is a continuation-in-part, of U.S. patent Ser. No. 10/176,298, entitled “A Scheduling System for Transmission of Cells to ATM Virtual Circuits and DSL Ports”, filed Jun. 18, 2002.

### BACKGROUND

Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes “payload” and a “header”. The packet's “payload” is analogous to the letter inside the envelope. The packet's “header” is much like the information written on the envelope itself and can include information to help network devices deliver the packet. A given packet may make many “hops” across intermediate network devices, such as “routers” and “switches”, before reaching its destination.

The structure and contents of a packet and the way the packet is handled depends on the networking protocol(s) being used. For example, in a protocol known as Asynchronous Transfer Mode (ATM), the packets (“ATM cells”) include identification of a “virtual circuit” (VC) and/or “virtual path” (VP) that connect a sender to a destination across a network.

Different applications using a network often have different characteristics. For example, an application sending out real-time video may require rapid delivery of a steady stream of cells. An e-mail application, however, may not require such timely service. To support these different applications, ATM provides different categories of services. These categories include a Constant Bit Rate (CBR) category that dedicates bandwidth to a given circuit or path; a Variable Bit Rate (VBR) category characterized by a Sustained Cell Rate (SCR) (an average transmission rate over time) and a Peak Cell Rate (PCR) (how closely spaced cells can be); and an Unspecified Bit Rate (UBR) category which provides the best-effort service a network device can offer given its other commitments. A given circuit may also be characterized by other Quality of Service (QoS) parameters, such as, a parameter governing cell loss, cell delay, and so forth.

A given network device may handle a very large number of circuits. While a device's capacity to forward cells is often large, it is limited. A First-In-First-Out approach to forwarding received cells may fail to satisfy the different QoS service categories and parameters associated with different circuits. Thus, many devices perform an operation known as “shaping.” Shaping involves ordering the transmission of received cells to provide satisfactory service to the different circuits.

### BRIEF DESCRIPTION OF THE DRAWINGS

FIGS. 1A-1D are diagrams illustrating a traffic management system.

FIG. 2 is a diagram of a schedule wheel.

FIG. 3 is a diagram of a hierarchical bit vector.

FIG. 4 is a diagram of a port bandwidth vector.

FIG. 5 is a diagram of a network processor.

FIGS. 6 and 7 are diagrams illustrating examples of implementations of the traffic management system using network processors.

FIG. 8 is a diagram of a network forwarding device.

### DETAILED DESCRIPTION

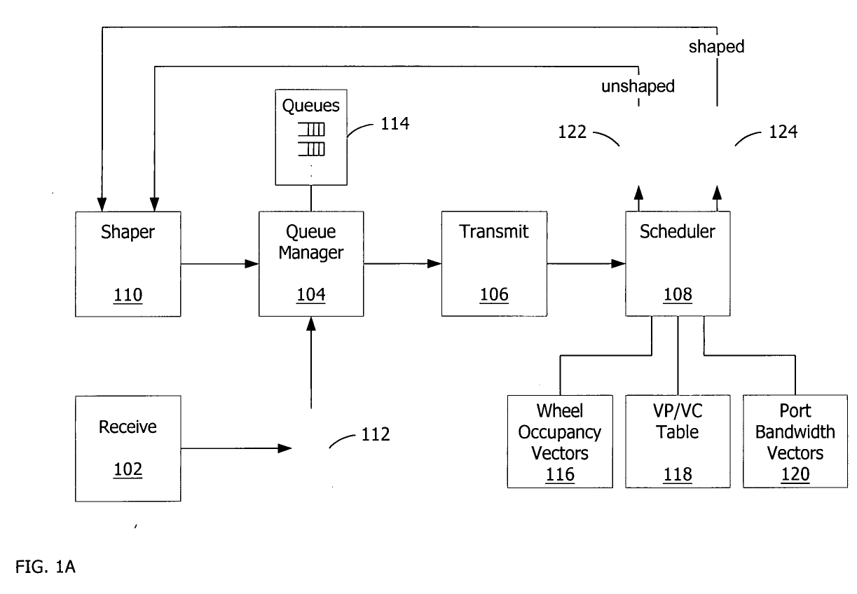

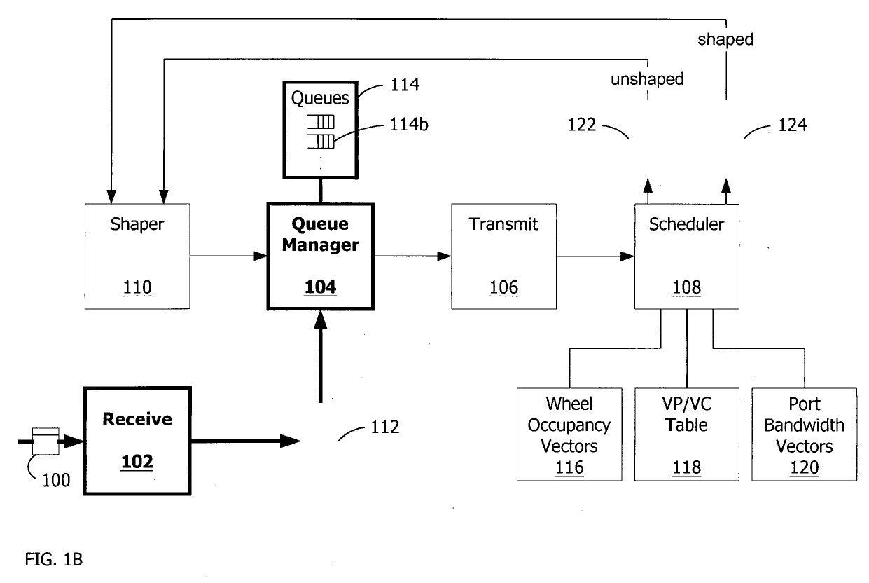

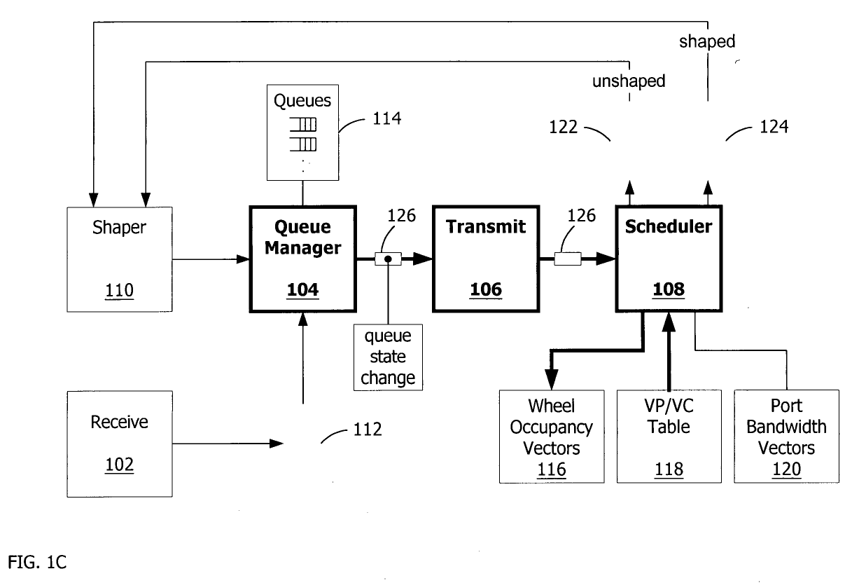

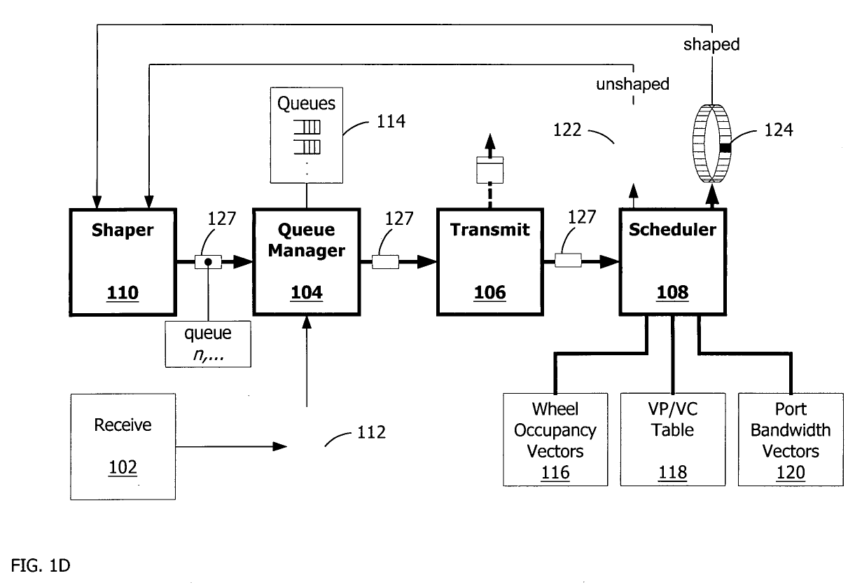

FIG. 1A depicts a packet forwarding system that efficiently shapes outbound traffic to conform to quality of service (QoS) characteristics of different connection flows. As shown, the system includes a schedule wheel 124 formed from a circular collection of scheduling slots. A scheduler process 108 populates slots in the scheduling wheel 124 with different flow candidates for transmission. The scheduler 108 performs this scheduling based on the QoS associated with a given connection and/or the availability of port bandwidth, in addition to other possible factors. A shaper process 110 “consumes” the scheduling slots in turn and determines which of the candidate flows to service at a given time. Schedule wheel 124 slots can prioritize flows for servicing, for example, based on their QoS characteristics.

In addition, to schedule wheel 124, the scheduler 108 may also identify 122 flows meriting best-effort service (“unshaped” traffic). The shaper 112 can opportunistically service these best-effort flows using residual bandwidth left unscheduled by the schedule wheel 124.

As shown in FIG. 1A, the scheduler 108 and shaper 110 can form part of a system that may also include queue manager 104 and transmit 106 processes. The queue manger 104 monitors the states of different packet queues 114. The transmit process 106 dequeues packets from their queues 114 and initiates their transmission in response to messages issued by the shaper 110.

Communication between the different components 110, 104,106,108 may be implemented in a variety of ways. For example, the components may exchange messages to take advantage of hardware resources that speed inter-process/inter-processor communication. Additionally, messages sent by the different components may be aggregated (e.g., into a single message) to simplify inter-process messaging. FIGS. 1B-1D illustrate operation of a sample implementation in greater detail.

As shown in FIG.1 B packets (e.g., ATM cells), such as packet 100, are collected by a receive process 102 as they arrive piecemeal. When a complete packet has arrived, the receive process 102 queues the packet in a receive message ring 112. Packets stored in the ring 112 are retrieved by the queue manager process(es) 104 and sorted into different queues 114 based on packet and/or flow characteristics. For example, different queues 114b may correspond to different virtual circuits or paths.

As shown in FIG. 1C, the queue manager 104 monitors the occupancy of different queues, for example, to determine when a queue enters or leaves an empty state. As shown, upon detecting a change in queue state, the queue manager 104 can send a message 126 identifying the queue (or virtual circuit associated with the queue). For economy, such a message 126 may be segmented into two sections: a first section identifying the queue(s) entering the empty state and a second section identifying the queue(s) leaving the empty state. As shown, the transmit process 106 passes the message 126 through to the scheduler 108.

The scheduler 108 uses the queue state messages 126 to update a best-effort vector identifying the state of queues associated with best-effort (e.g., UBR) virtual circuits. That is, a bit in the best-effort vector identifies whether a queue associated with a best-effort circuit currently holds any packets. The scheduler 108 scans the vector and queues 122 messages to the shaper 110 (e.g., via a message ring 122) identifying which “best-effort” queues to service when an opportunity arises. Such a message can include a block (e.g., 32-bits) of the vector. Since the vector may be large (e.g., 32K bits for 32K queues) and sparsely occupied, the message identifying the block of bits may also include an offset identifying the location of the block within the larger vector. This permits the scheduler 108 to skip large stretches of the vector where no best-effort queues require service.

As shown in FIG. 1D, in addition to handling best-effort traffic, the scheduler 108 also populates the schedule wheel 124. For example, for a given virtual circuit, the scheduler 108 can schedule a cell of the circuit for possible transmission by storing identification of the circuit within a slot of wheel 124. The slot selected can be calculated based on the traffic parameters 118 associated with the circuit and data identifying the last time a cell was transmitted for the circuit. Potentially, the scheduler 108 can schedule a circuit for servicing at multiple slots at a time. For example, for a CBR circuit, the scheduler 108 can enter several schedule entries for the circuit at uniform intervals.

As shown in FIG. 1D, the shaper 110 accesses the schedule wheel 124 to select queues/circuits to service. As shown, based on the selection, the shaper 110 generates a message 127 identifying which queue(s) 114 to service. Such a message may also include identification of the type of circuit (e.g., shaped or unshaped). The queue manager 104 dequeues packets from the identified queue(s) and passes the message 127 through to the transmit process 106 (potentially with a “piggybacked” queue state change message 126 (FIG.1B)). The transmit process 106 initiates transmission of the dequeued cells, for example, by sending the cells over a switch fabric to an egress port leading to the next network device in the circuit. The transmit process 106 also passes the message 127 onto the scheduler 108. For queues associated with shaped flows, the scheduler attempts to schedule a next servicing of the identified queues in wheel 124.

For scheduled candidates not selected for servicing (e.g., a higher priority circuit is chosen for transmission over a particular port), the shaper can send a message identifying the circuit to the scheduler 108 for rescheduling.

The system described above may also respond to the flow-control status of different ports. That is, a given port may signal congestion detected in a downstream link. In response, the system (e.g., shaper 110 or other process) may temporarily “hold up” circuits scheduled for transmission over the congested ports. For example, the shaper 110 may maintain a per port queue of virtual circuit indices to identify those virtual circuits that were not scheduled for transmission due to flow control assertion. When the port reports (e.g., via a control and status register) that the flow control has been de-asserted for the port, the shaper 110 can dequeue entries from the per port queue for the port and send re-schedule messages to the scheduler for the previously stalled flows. Potentially, the shaper 110 may store the traffic class associated with virtual circuits in the per port queue and use this information to prioritize (e.g., CBR before VBR) re-scheduling.

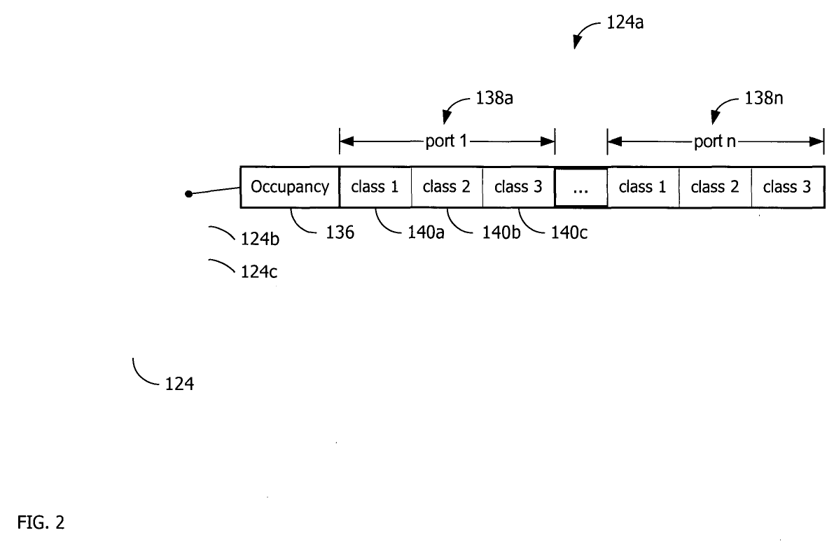

FIG. 2 illustrates a schedule wheel 124 in greater detail. As shown, the wheel includes a collection of slots 124a, 124b, 124c. Each slot represents some period of time. The shaper “clicks” through the slots of the wheel in turn. For example, the shaper will advance to slot 124a for n-processing cycles, then advance to slot 124b. The number of slots in the wheel 124 and the number of processing cycles per slot may be configured based on a variety of factors (e.g., aggregate egress bandwidth, minimum bandwidth supported, number of virtual circuits supported, and so forth).

As shown, an individual slot 124a includes an array of service candidates 138 for each egress port. For example, candidate set 138a identifies candidate virtual circuits 140 that the shaper may select for transmission via port “a”. As shown, the candidates 138a associated with a port may be divided into different transmission priority classes. For example, the shaper can select a virtual circuit identified in class 2 140b for servicing if no virtual circuit is identified in class 1 140a. In this example, class 3 may correspond “could send” virtual circuits (e.g., VBR-nrt virtual circuits); class 2 may correspond to a higher class of “could send” virtual circuits (e.g., VBR-rt virtual circuits); while class 1 may correspond to “must send” virtual circuits (e.g., CBR virtual circuits or VBR virtual circuits whose service parameters [e.g., SCR] do not permit further delay of service). Potentially, the scheduler 108 may schedule best-effort circuits for transmission in the schedule wheel 124. For example, a UBR class circuit may be scheduled in class “3” if the percentage of best-effort based on the amount or percent of best-effort traffic relative to traffic of other QoS service categories.

The individual schedule entries (e.g., entry 140a for class 1) can include a queue, circuit, and/or path identifier to help the queue manager to identify the queue to service. An entry 140a may include additional information such as the egress port to use to transmit circuit packets. This permits the shaper to pass this information to the transmit process without an additional lookup. Additionally, an entry 140a may include identification of whether the circuit is associated with shaped or unshaped handling. This permits the shaper 110 to pass this information back to the scheduler 108 when the shaper 110 selects a given circuit for transmission. The shaper 110 can pass this information onto the scheduler 108 to signal that a serviced circuit should be scheduled for servicing again.

As shown, a slot 124a may also include a slot occupancy vector 136 that stores a series of bits that identify which ports have at least one scheduling entry. For example, an occupancy vector of “1 0” indicates that port “1” has been scheduled in at least one class 140 for at least one virtual circuit, but port n has not. If a port has not been scheduled for a virtual circuit by the time the shaper processes the slot, the shaper can use this opportunity to send out a cell of an unshaped (e.g., UBR class) circuit via an otherwise idle port.

Again, virtual circuits are assigned to different slots by scheduler 108 based on the circuits' service classes and/or other QoS characteristics. To schedule a virtual circuit, the scheduler 108 determines the earliest and latest schedule wheel 124 slot consistent with a circuit's QoS characteristics. The scheduler can search within this band of slots for a slot in the schedule wheel 124 having an available (e.g., previously unassigned) schedule entry for the appropriate class and port. For example, based on a last previous cell transmission on a given virtual circuit and the circuits' QoS category and parameters, the scheduler 108 may identify a particular slot within the wheel 124 and attempt to assign a virtual circuit to a schedule entry 138a of the appropriate class in that slot for the port used to transmit cells for the circuit. If the entry 138a had previously been assigned to another cell, the scheduler 108 can attempt to find another slot to schedule the virtual circuit, for example, using a linear search of subsequent slots.

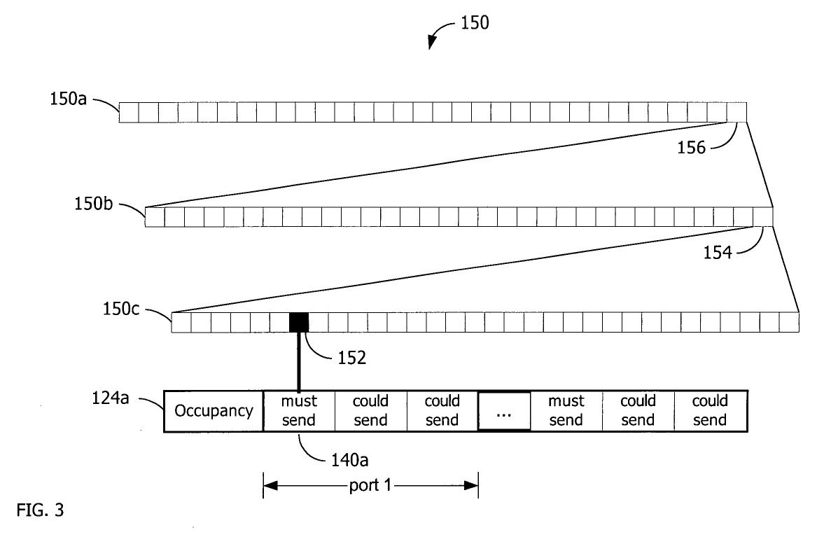

To speed the search for available slot entries, the scheduler may maintain hierarchical bit vectors identifying the occupancy of different slot entries. For example, as shown in FIG. 3, a system may use a different hierarchical bit vector 150 for each class of each port. For instance, vector 150 may identify occupancy of class “1” entries 138a associated with port “a”.

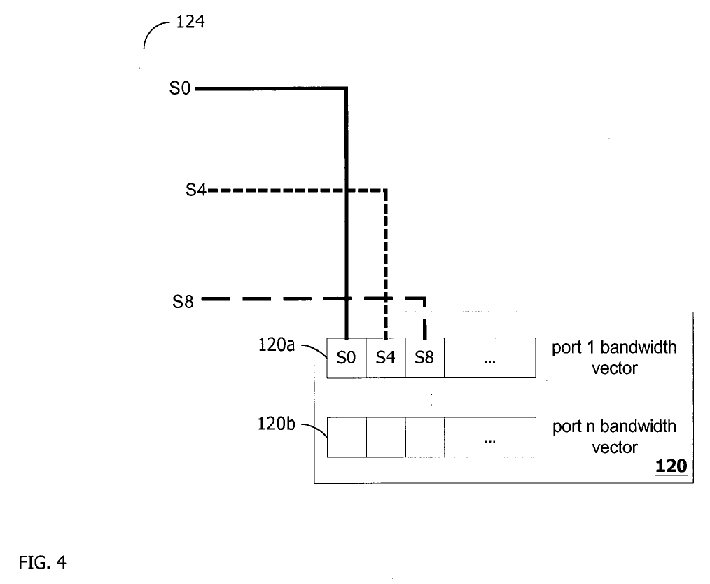

The vector 150 shown in FIG. 3 includes different hierarchical layers 150a, 150b, and 150c. The lowest layer 150c includes a bit identifying the occupancy of port “a” class “1 ” entries for 32 slots. For example, bit-1 of lower layer 150 corresponds to the occupancy of a class “1” entry for port “a” in slot 1 of the schedule wheel. In the illustration, bit 152 (filled) identifies that the entry for class “1” for port “a” in slot 124a holds a virtual circuit candidate for transmission. Though FIG. 4 shows one set 150c of lower layer bits, the vector 150 actually includes n-sets. For example, 1024-sets of 32 bits would provide 1 bit for the 32K different slots of a schedule wheel.

The middle layer 150b of the vector 150 includes bits identifying the aggregated occupancy of the lower layer sets 150c. For example, bit 154 of vector 150b identifies whether all of the 32-bits within lower layer set 150c are occupied. That is, bit 154 indicates whether any of the lower layer bits in set 150c are available. Since, not all of the bits of lower layer set 150c are occupied, the bit 154 is illustrated as blank (e.g., “off”). Again, while FIG. 4 shows only one set of middle layer bits 150b, the vector 150 may include many different sets (e.g., 32-sets of 32 bits).

The top layer 150a in FIG. 4 includes bits identifying occupancy of sets of the middle layer 150b bits. For example, as shown in FIG. 4, bit 156 of the top layer identifies whether all of the bits in the set 150b of middle layer bits are occupied. Thus, the bit identifies whether any of 32 bits in middle layer 150b are filled and, in turn, indicates whether any of 1024 bits in the lower layer are currently occupied.

Again, the hierarchical bit vector 150 permits quick identification of available scheduling opportunities. For example, by searching the top and/or middle layers, the scheduler can quickly skip large blocks of previously assigned scheduling opportunities instead of a brute-force sequential search.

Hierarchical bit vectors may be used by the system to handle other data. For example, In addition to use to identify occupancy of entries in the schedule wheel 124, a hierarchical bit vector may also be used to track the queue occupancy best-effort circuits.

Potentially, even though a given scheduling entry in a slot is unoccupied, a port may not have sufficient bandwidth to handle scheduling of a cell in that slot. To prevent over-scheduling of a port's limited bandwidth, the system may maintain port bandwidth vectors for the different ports.

FIG. 4 illustrates an example of a port bandwidth vector 120a for port “a”. In the example, port “a” is assumed to provide ¼ of the aggregate bandwidth (e.g., an OC-48 port of an OC-192 system). Thus, at most, each successive bit within the vector 120a corresponds to each fourth slot of the schedule wheel. For example, the first bit corresponds to slot S0 while the second bit corresponds to slot S4. Additional data (not shown) may identify the slot associated with each bit. The scheduler can set a bit of the vector 120a when a must-send schedule entry is filled for the port. The vector 120a prevents the scheduler from scheduling transmission on a given port at a rate greater than the bandwidth provided by a port. For example, assuming first bit of vector 120a was previously associated with slot S0, the next bit of the vector 120 cannot be associated with S1, S2, or S3 assuming the port contributes ¼ of the aggregate bandwidth. The “origin” of the vector 120a (e.g., S0) may not be defined until a cell is transmitted over the port initially or after the port has no scheduled transmissions.

More specifically, the vector 120a has a dimension of (total slots in wheel/port bandwidth represented in a slot). For example, assuming a port contributes ¼ of the aggregate bandwidth and a wheel includes 32,000 slots, the vector 120a would have a dimension of 8,000. When attempting to schedule a circuit, the scheduler can check the vector 120a bit at bit-position (current slot location schedule wheel/ port bandwidth represented in slots). If already occupied or if in violation of the port's bandwidth (e.g., the current slot is between S0 and S4), the scheduler can continue searching for an empty schedule entry.

In the sample implementation shown in FIGS. 1A-1D, the port bandwidth vectors 120 are accessed by the scheduler 108 when making scheduling decisions. Incorporating port bandwidth considerations into the scheduling 108 alleviates, at least in part, the burden of such analysis from the shaper 110. This approach can also permit the shaper 110 to avoid several memory operations (e.g., to retrieve information about a ports bandwidth usage).

While FIGS. 1-4 described a sample implementation, many other implementations may use techniques described above. For example, the scheduler process may be situated in the receive path of a packet (e.g., the path of processes handling the packet before the packed is finally queued). Additionally, while FIG. 4 described a port bandwidth vector, other implementations may not feature such a vector. For example, a given port may be dedicated to a regular, repeating interval of schedule slots that ensures port bandwidth is preserved. In yet another embodiment, the system may maintain different schedule wheels for different ports (e.g., one wheel per port).

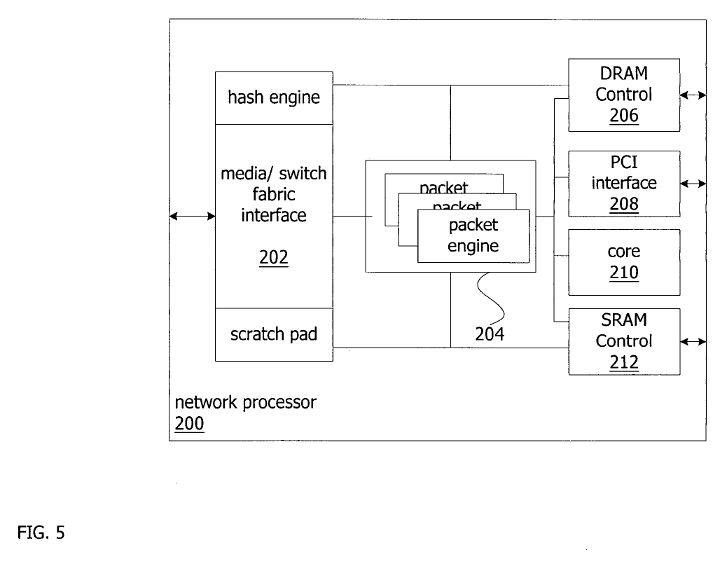

The techniques described above may be used in a wide variety of systems. For example, FIG. 5 depicts a programmable network processor 200 that features multiple packet engines 204. The network processor 200 shown is an Intel® Internet eXchange network Processor (IXP) 2000 series. Other network processors feature different designs.

As shown, the network processor 200 features an interface 202 (e.g., an Internet eXchange bus interface) that can carries packets between the processor 200 and network components. For example, the bus may carry packets received via physical layer (PHY) components (e.g., wireless, optic, or copper PHYs) and link layer component(s) 222 (e.g., MACs and framers). The processor 200 also includes an interface 208 for communicating, for example, with a host. Such an interface may be a Peripheral Component Interconnect (PCI) type interface such as a PCI-X bus interface. The processor 200 also includes other components such as memory controllers 206, 212, a hash engine, and scratch pad memory.

The network processor 200 shown features a collection of packet engines 204. The packet engines 204 may be Reduced Instruction Set Computing (RISC) processors tailored for network packet processing. For example, the packet engines may not include floating point instructions or instructions for integer multiplication or division commonly provided by general purpose central processing units (CPUs).

An individual packet engine 204 may offer multiple threads. The multi-threading capability of the packet engines 204 is supported by context that reserves different general purpose registers for different threads and can quickly swap between the different threads. An engine 204 may also feature a small amount of local memory.

The network processor 200 may provide a variety of hardware assisted mechanisms for communication between threads and engines 204. For example, the threads may use scratchpad or SRAM memory to read/write inter-thread messages. Additionally, individual packet engines 204 may feature memory (e.g., a neighbor register) connected to high speed data bus(es) hard-wired to one or more neighboring packet engine.

The processor 200 also includes a core processor 210 (e.g., a StrongARM® XScale®) that is often programmed to perform “control plane” tasks involved in network operations. The core processor 210, however, may also handle “data plane” tasks and may provide additional datagram processing threads.

Traffic management techniques described above may be implemented in a way to take advantage of features offered by a network processor's architecture. For example, the processes shown in FIGS. 1A-1D may be implemented as threads on successive packet engines 204. This permits the threads 110, 104, 106, 108 to communicate with threads on immediately succeeding engines using the neighbor registers that connect the different packet engines. For example, to communicate a queue state change, a queue manager thread operating on one engine 204 may store a queue state change message 126 in the engine's neighbor register. A transmit process thread operating on an adjacent packet engine 204 can access the neighbor register to pick up the message 126. Similarly, communication between the shaper 110 and queue manager 104, queue manager 104 and transmit process 106, and transmit process 106 and scheduler 108 may communicate using the neighbor registers or in hardware managed rings resident in the scratchpad or SRAM. Additionally, the engines 204 may include “reflector” registers that interconnect non-adjacent engines. For example, a shaper thread operating on one engine may write the current slot being handled to an engine handling scheduler thread(s) to enable the scheduler thread(s) to determine the earliest time horizon when a cell may be scheduled.

The different threads can also communicate using shared memory. For example, the queue manager can send queue state change messages to the scheduler via a message ring stored in the network processor scratchpad. In such an implementation, the queue state change data does not need to pass through the transmit process.

The local memory of a packet engine may be used to cache data for use by different engine threads. For example, potentially, the traffic parameters associated with a given flow (e.g., CBR flows exceeding some threshold data rate) may be cached in a packet engine executing a scheduling thread. This caching can, potentially, enable subsequent handling of another cell in the same flow to be handled faster. Additionally, the schedule wheel occupancy vector(s) may be cached in a packet engine so that scheduler threads executing on a given engine can potentially avoid duplicate memory reads requests from external memory. For example, a set of lower level bits of the hierarchical bit vector that identifies schedule wheel vacancies may be cached, for example, for fast flows. This permits scheduling of many cells, potentially, without renavigating the hierarchical bit vector to find vacancies. That is, a scheduling thread can simply look for the next vacancy within the cached set of lower level bits.

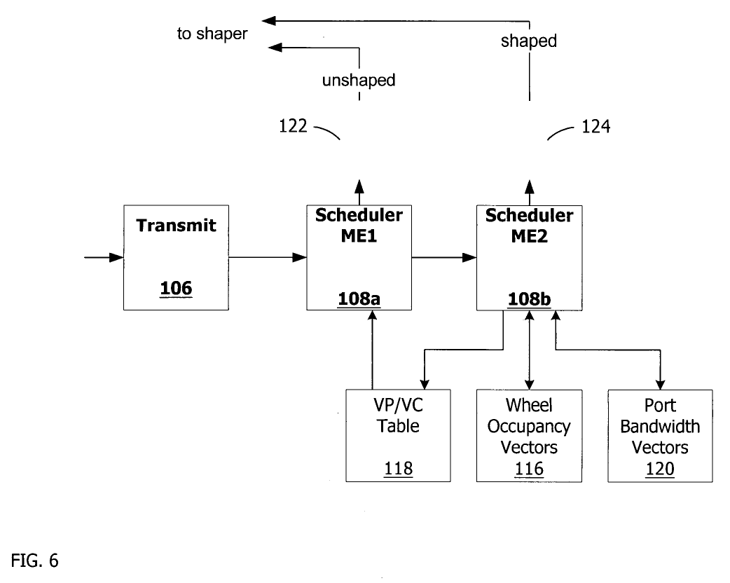

In addition to these inter-thread communication mechanisms, the components shown in FIGS. 1A-1D may be partitioned across multiple packet engines. For example, as shown in FIG. 6, scheduler threads may be divided into threads operating on different packet engines 108a, 108b. Broadly speaking, the first engine 108a handles duties associated with unshaped traffic while the second engine 108b handles duties associated with shaped traffic.

As shown, scheduler threads operating on the first packet engine 108a update the best-effort occupancy vector based on messages from the queue manager 104. One of the threads on the first packet engine can buffer 122 messages identifying non-empty best-effort queues by scanning the best-effort vector. For shaped circuits, scheduling threads on the first packet engine 108a can retrieve traffic parameters 118 for the circuit, off-loading this task from the second packet engine 108b. Such off-loading is efficiently performed using the high speed bus between engines.

Scheduling threads on the first packet engine 108a pass on messages to the scheduling threads on the second packet engine 108b. In response to the messages, threads on the second engine 108b assign shaped circuits to slots in the schedule wheel.

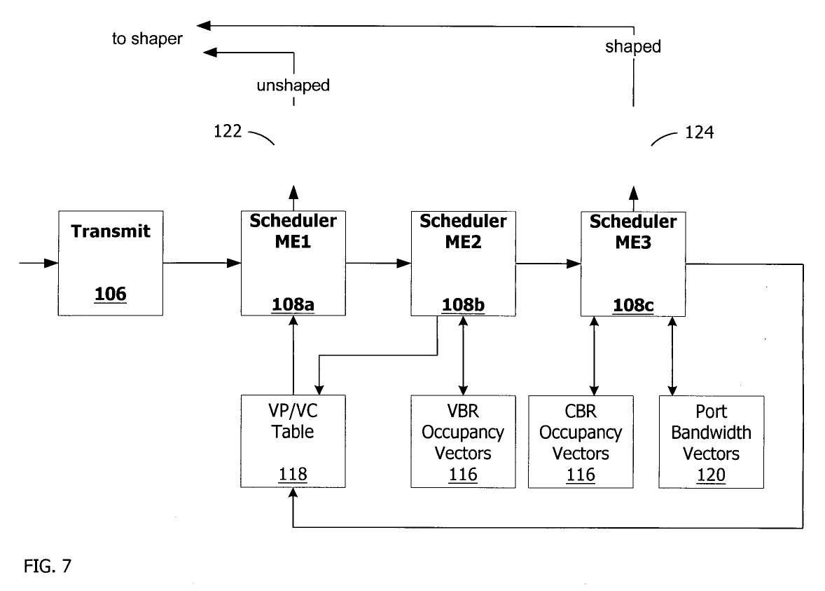

FIG. 7 illustrates yet another implementation. As shown, the scheduler process 108 is divided into threads on three different engines 108a, 108b, 108c. Scheduler threads in the first engine 108a handles best-effort traffic (much like engine 108a in FIG. 6), scheduler threads in the second engine 108a handle VBR circuits; while scheduler threads in the third engine handle CBR circuits.

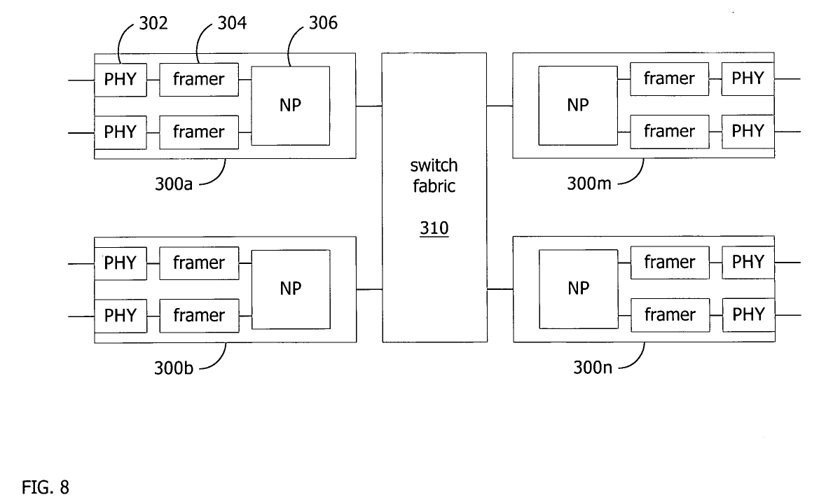

FIG. 8 depicts a network forwarding device incorporating techniques described above. As shown, the device features a collection of line cards 300 (“blades”) interconnected by a switch fabric 310 (e.g., a crossbar or shared memory switch fabric). The switch fabric, for example, may conform to CSIX. Other fabric technologies include HyperTransport, Infiniband, PCI-X, Packet-Over-S0NET, RapidIO, and Utopia.

Individual line cards (e.g., 300a) include one or more physical layer (PHY) devices 302 (e.g., optic, wire, and wireless PHYs) that handle communication over network connections. The PHYs translate between the physical signals carried by different network mediums and the bits (e.g., “0”-s and “1”-s) used by digital systems. The line cards 300 may also include framer 304 devices (e.g., Ethernet, Synchronous Optic Network (S0NET), or High-Level Data Link (HDLC) framers) that can perform operations on frames such as error detection and/or correction. The line cards 300 shown also include one or more network processors 306 that execute instructions to process packets (e.g., framing, selecting an egress interface, and so forth) received via the PHY(s) 302 and direct the packet's, via the switch fabric 310, to a line card providing the selected egress interface.

Again, while the above described details of sample implementations, a wide variety of other implementations may be employed. For example, a system may implement multiple schedule wheels and store the different schedule wheels in memories having different latency. For instance, a schedule wheel associated with circuits having high data rates may be stored in scratchpad memory local to packet engines, while a schedule wheel associated with lower data rate circuits may be stored higher latency SRAM. Additionally, while described as a system for handling ATM cells, the packet may conform to a different protocol (e.g., Internet Protocol) and/or reside in a different layer within a protocol stack.

The techniques may be implemented in hardware, software, or a combination of the two. For example, the techniques may be implemented by programming a network processor or other processing system. The programs may be disposed on computer readable mediums and include instructions for causing processor(s) to execute instructions implementing the techniques described above.

Other embodiments are within the scope of the following claims.

1. A system to process packets received over a network, the system comprising:
a receive process of at least one thread of a network processor, the receive process to receive data of packets, different ones of the packets belonging to different flows; and
a transmit process of at least one thread of the network processor to transmit packets received by the receive process;
a scheduler process of at least one thread of the network processor to populate at least one schedule of flow service based, at least in part, on quality of service characteristics associated with the different flows, the at least one schedule identifying different flow candidates for service; and
a shaper process of at least one thread of the network processor to select from the candidate flows for service from the at least one schedule.

2. The system of claim 1, wherein
the packets comprise Asynchronous Transfer Mode (ATM) cells;
the flows comprise at least one of virtual circuits and virtual paths; and
the quality of service characteristics comprise at least one of the following classes: Constant Bit Rate (CBR) and Variable Bit Rate (VBR).

3. The system of claim 1, wherein the system further comprises a queue manager process of at least one thread of the network processor to queue packets based on their associated flow.

4. The system of claim 3, wherein the queue manager is situated in a process-flow before the scheduler.

5. The system of claim 1, wherein at least one of the process threads communicates a message to a thread in a subsequent one of the processes via at least one neighbor register provided by a packet engine processing the at least one of the process threads.

6. The system of claim 1, wherein at least one thread of the scheduler process comprises more than one thread, different ones of the threads operating on different packet engines of the network processor.

7. The system of claim 1, wherein the at least one schedule comprises a schedule wheel having a collection of slots, an individual slot including an array of entries corresponding to different egress ports.

8. The system of claim 7, wherein individual entries within the array of entries comprise flow service candidates assigned to different service priorities.

9. The system of claim 7, wherein the at least one scheduler thread comprises at least one thread to cache at least one of the following in memory of a packet engine in the network processor: traffic parameters of a flow and a portion of a schedule wheel occupancy vector identifying scheduling candidate vacancies in the scheduling wheel.

10. The system of claim 7, wherein the at least one thread of the scheduler process comprises a thread to schedule service of a flow based, at least in part, on a port bandwidth vector associated with an egress port used to transmit packets, individual elements within the port bandwidth vector identifying whether a particular port has been reserved for transmission, individual elements within the port bandwidth vector corresponding to different slots within the at least one schedule wheel.

11. The system of claim 1, wherein the schedule comprises multiple schedule wheels, different wheels corresponding to different ports.

12. The system of claim 1, wherein
the at least one thread of the scheduler process comprises at least one thread to identify flows associated with best-effort service; and
the at least one thread of the shaper process comprises at least one thread to service a best-effort flow using egress port bandwidth unscheduled by the at least one schedule.

13. The system of claim 12, wherein the at least one thread to identify flows associated with best-effort service comprises at least one thread to send a message to at least one shaper thread identifying a subset of a best-effort vector, individual entries in the best-effort vector corresponding to a flow.

14. The system of claim 12,
wherein the at least one shaper thread identifies a schedule wheel slot processed by the shaper; and
wherein the at least one scheduler thread schedules a flow for service based on the identified schedule wheel slot.

15. The system of claim 12, wherein the at least one shaper thread processes each slot for the same amount of time.

16. The system of claim 1, wherein the at least one shaper thread:
queues flows associated with ports having flow control asserted; and
dequeues the flows after flow control is deasserted.

17. The system of claim 16, wherein
the shaper thread queues the flows with identification of classes of service associated with the flows and selects flows for servicing after flow control is deasserted based on the identification.

18. The system of claim 1, wherein the at least one of thread of the schedule process comprises a thread to schedule a flow for service in multiple slots.

19. A computer program product, disposed on a computer readable medium, the product including instructions for causing packet engines of a network processor to provide:
a receive process of at least one thread of a network processor, the receive process to receive data of packets, different ones of the packets belonging to different flows; and
a transmit process of at least one thread of the network processor to transmit packets received by the receive process;
a scheduler process of at least one thread of the network processor to populate at least one schedule of flow service based, at least in part, on quality of service characteristics associated with the different flows, the at least one schedule identifying different flow candidates for service; and
a shaper process of at least one thread of the network processor to select from the candidate flows for service based on the at least one schedule.

20. The product of claim 19, wherein
the packets comprise Asynchronous Transfer Mode (ATM) cells;
the flows comprise at least one of virtual circuits and virtual paths; and
the quality of service characteristics comprise at least one of the following categories: Constant Bit Rate (CBR) and Variable Bit Rate (VBR).

21. The product of claim 19, wherein the instructions further comprise a queue manager process of at least one thread of the network processor to queue packets based on their associated flow.

22. The product of claim 19, wherein at least one of the process threads communicates a message to a thread in a subsequent one of the processes via at least one neighbor register provided by a packet engine processing the at least one of the process threads.

23. The product of claim 19, wherein at least one thread of the scheduler process comprises more than one thread, different ones of the threads operating on different packet engines of the network processor.

24. The product of claim 19, wherein the schedule comprises a collection of slots, an individual slot including an array of entries corresponding to different egress ports.

25. The product of claim 24, wherein individual entries within the array of entries comprise flow service candidates assigned to different service priorities.

26. The product of claim 24, wherein the at least one thread of the scheduler process comprises a thread to schedule service of a flow based, at least in part, on a port bandwidth vector associated with an egress port, individual elements within the port bandwidth vector identifying whether a particular port has been reserved for transmission at a particular slot.

27. The product of claim 19, wherein
the at least one thread of the scheduler process comprises at least one thread to identify flows associated with best-effort service; and
the at least one thread of the shaper process comprises at least one thread to service a best-effort flow using egress port bandwidth unscheduled by the at least one schedule.

28. The product of claim 27, wherein the at least one thread to identify flows associated with best-effort service comprises at least one thread to send a message to a shaper thread identifying a subset of a best-effort vector, individual entries in the best-effort vector corresponding to a flow associated with best-effort service.

29. The product of claim 19, wherein the at least one scheduler thread comprises at least one thread to cache traffic parameters of a flow in packet engine memory.

30. A system to process Asynchronous Transfer Mode (ATM) cells received over a network, the system comprising:
multiple line cards, an individual line card including:
at least one physical layer component (PHY); and
at least one network processor having multiple packet engines having access to instructions to provide:
a receive process of at least one thread of a network processor, the receive process to receive data of cells, different ones of the cells belonging to different virtual circuits; and
a transmit process of at least one thread of the network processor to transmit cells received by the receive process;
a scheduler process of at least one thread of the network processor to generate at least one schedule for virtual circuit service, based at least in part, on quality of service classes associated with the virtual circuits, the at least one schedule comprising a schedule wheel having a collection of slots, an individual slot including an array of entries corresponding to different ports, individual entries within the array of entries including virtual circuit service candidates assigned to different service priorities; and
a shaper process of at least one thread of the network processor to identify virtual circuits to service based on the schedule wheel slots; and
a switch fabric interconnecting the multiple line cards.

31. The system of claim 30, wherein at least one of the process threads communicates a message to a thread in a subsequent one of the processes via at least one neighbor register provided by a packet engine processing the at least one of the process threads.

32. The system of claim 30, wherein the at least one thread of the scheduler process comprises a thread to schedule service of a flow based, at least one part, on a port bandwidth vector associated with an egress port used to transmit packets for the flow, individual elements within the vector identifying whether a particular port has been reserved for transmission at a particular slot.

33. The system of claim 30, wherein
the at least one thread of the scheduler process comprises at least one thread to identify flows associated with best-effort service; and
the at least one thread of the shaper process comprises at least one thread to service a best-effort flow using egress port bandwidth unscheduled by the at least one schedule.

34. The system of claim 33, wherein the at least one thread to identify flows associated with best-effort service comprises at least one thread to send a message to a shaper thread identifying a subset of a best-effort vector, individual entries in the best-effort vector corresponding to a flow associated with best-effort service.
